(19) United States
(12) Patent Application Publication
(10) Pub. No.: US 2008/0320415 A1
(43) Pub. Date: Dec. 25, 2008

(54) APPARATUS, METHOD AND COMPUTER-READABLE STORAGE MEDIUM FOR ACCESSING MEDIA CONTENT

(75) Inventor: Christian Ostergaard, Vaerlose (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/767,220

(22) Filed: Jun. 22, 2007

(51) Int. Cl. G06F 3/048

(52) U.S. Cl. 715/810

(57) ABSTRACT

An apparatus is configured to present a graphical user interface (GUI) that includes category, subcategory and media content fields. The category field identifies therein categories associated with pieces of media content. The apparatus is configured to receive selection of an identified category, and in response thereto, (a) note the selected category in the category field of the GUI; and (b) identify, in the subcategory field of the GUI, subcategories associated with piece of media content, and in the hierarchy, logically underneath the selected category. The apparatus is also configured to receive selection of an identified subcategory, and in response thereto, (a) note the selected subcategory in the subcategory field of the GUI; and (b) identify, in the media content field of the GUI, pieces of media content logically underneath the selected subcategory in the hierarchy. The apparatus is then configured to receive selection of an identified piece of media content.

### FIELD OF THE INVENTION

The present invention generally relates to systems and methods of accessing multimedia content, and more particularly, relates to a systems and methods for accessing media content via a graphical user interface (GUI) for selecting categories and/or subcategories associated therewith.

### BACKGROUND OF THE INVENTION

With the fast development of hardware technology, the abilities of an electronic device, such as a mobile terminal, to process data and to store information are remarkably improved, by which users can enjoy kinds of multimedia applications anytime and anywhere. As an example, many new models of mobile phones integrate MP3 player and/or radio, which can provide music and broadcast programs to the users.

Conventionally, users of an electronic device having a music database can browse or retrieve music stored in the music database, and find out, if needed, a piece of music, by entering descriptive keywords, such as title, performer and composer of the piece of music, to listen or to download it to other devices.

When users browse or access one or more pieces of music from a music database stored in the electronic device, a menu or a list of pieces of music is displayed on the display unit of the electronic device. The menu or list shows, usually in text mode, a large number of titles, names of performers, names of composers etc. of the pieces of music to be selected. The users need to select what they want from the menu or list based on a certain rule such as alphabet order. And although numerous techniques have been developed for browsing and accessing media content, it is typically desirable to improve upon existing techniques.

### SUMMARY OF THE INVENTION

In light of the foregoing background, embodiments of the present invention provide an improved apparatus, method and computer-readable storage medium and method for accessing a piece of media content or information related thereto. According to one aspect of exemplary embodiments of the present invention, the apparatus includes a processor configured to present, in a display, a graphical user interface (GUI). The GUI fills a window area and includes a category field, a subcategory field and a media content field. The category field identifies therein one or more categories associated with one or more pieces of media content. Initially, one or both of the subcategory field or media content field is empty or collapsed.

The categories are included in a hierarchy including one or more subcategories logically underneath respective categories, and one or more pieces of media content logically underneath respective subcategories. In this regard, the categories may comprise criteria, and the subcategories may comprise particular values of the respective criteria.

The processor is configured to receive selection of a category identified in the category field. In response to receiving the selection of a category, the processor is configured to note the selected category in the category field of the GUI, such as by displaying but rendering un-selectable (e.g., graying out) one or more un-selected categories in the category field. Also in response to receiving the selection of a category, the processor is configured to identify, in the subcategory field of the GUI, one or more subcategories associated with one or more piece of media content, and in the hierarchy, logically underneath the selected category.

The processor is also configured to receive selection of a subcategory identified in the subcategory field, and in response to receiving the selection of a subcategory, note the selected subcategory in the subcategory field of the GUI, such as by displaying but rendering un-selectable one or more un-selected subcategories in the subcategory field. In such instances, the selected category may continue to be noted as the selected subcategory is noted. Also in response to receiving the selection of a subcategory, the processor is configured to identify, in the media content field of the GUI, one or more pieces of media content logically underneath the selected subcategory in the hierarchy. The processor is then configured to receive selection of a piece of media content identified in the media content field to thereby access the respective piece of media content or information related thereto.

One or both of the category field or subcategory field may be horizontally scrollable when identifying therein one or more categories or subcategories, respectively. Similarly, the media content field may be vertically scrollable when identifying therein one or more pieces of media content.

When selection of a category is received, the category field may be active and the subcategory and media content fields may be inactive. Similarly, when selection of a subcategory is received, the subcategory field may be active and the category and media content fields may be inactive. And when selection of a piece of media content is received, the media content field may be active and the category and subcategory fields may be inactive.

One or more of the category field, subcategory field or media content field may include therein a frame, where the frame may be movable with respect to the identified therein one or more categories, subcategories or pieces of media content, respectively. In such instances, the processor may be configured to receive selection of one or more of a category, subcategory or piece of media content aligned with the frame in one or more of the category field, subcategory field or media content field, respectively.

In instances in which at least the category field includes a frame, the processor may be configured to present a window area including a category field identifying a category aligned with a frame. The processor may then be further configured to identify, in the subcategory field of the GUI and before receiving selection of a category, one or more subcategories associated with one or more piece of media content, and in the hierarchy, logically underneath the category aligned with the frame. In this regard, the respective one or more subcategories may be displayed but un-selectable unless and until selection of the respective category is received.

The processor may be further configured to present the GUI further filling a second window area and including at least a second category field. The second category field may identify therein one or more categories associated with the selected piece of media content. In such instances, the processor may be further configured to receive selection of a category identified in the second category field. In response to receiving the selection of a category, the processor may be configured to note, in the second category field of the GUI, the selected category. Also in response to receiving the selection of a category, the processor may be configured to identify, in the second subcategory field of the GUI, one or more subcategories associated with the selected piece of media content, and in the hierarchy, logically underneath the selected category.

Even further, the processor may be configured to receive selection of a subcategory identified in the second subcategory field. In response to receiving the selection of a subcategory, the processor may be configured to note, in the second subcategory field of the GUI, the selected subcategory, where the selected category may continue to be noted as the selected subcategory is noted. And also in response to receiving the selection of a subcategory, the processor may be configured to identify, in the second media content field of the GUI, one or more pieces of media content logically underneath the selected subcategory in the hierarchy, where the identified one or more pieces of media content include the selected piece of media content.

According to other aspects of the present invention, a computer-readable medium and method are provided. Embodiments of the present invention therefore provide an improved apparatus, method and computer-readable storage medium for accessing a piece of media content or information related thereto. As indicated above, and explained below, exemplary embodiments of the present invention may solve problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one exemplary embodiment of the present invention including a cellular network and a data network to which a terminal is bi-directionally coupled through wireless RF links;

FIG. 2 is a schematic block diagram of an entity configured to operate as a terminal, origin server, digital broadcast receiving terminal and/or a digital broadcaster, in accordance with exemplary embodiments of the present invention;

FIG. 3 is a more particular schematic block diagram of a terminal, according to exemplary embodiments of the present invention;

FIG. 4 is a functional block diagram of an apparatus according to exemplary embodiments of the present invention;

FIGS. 5-12 illustrate various views of a graphical user interface presented by a playback application of an apparatus, according to exemplary embodiments of the present invention; and

FIG. 13 is a flowchart including various steps in a method of accessing a piece of media content or information related thereto, according to one exemplary embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

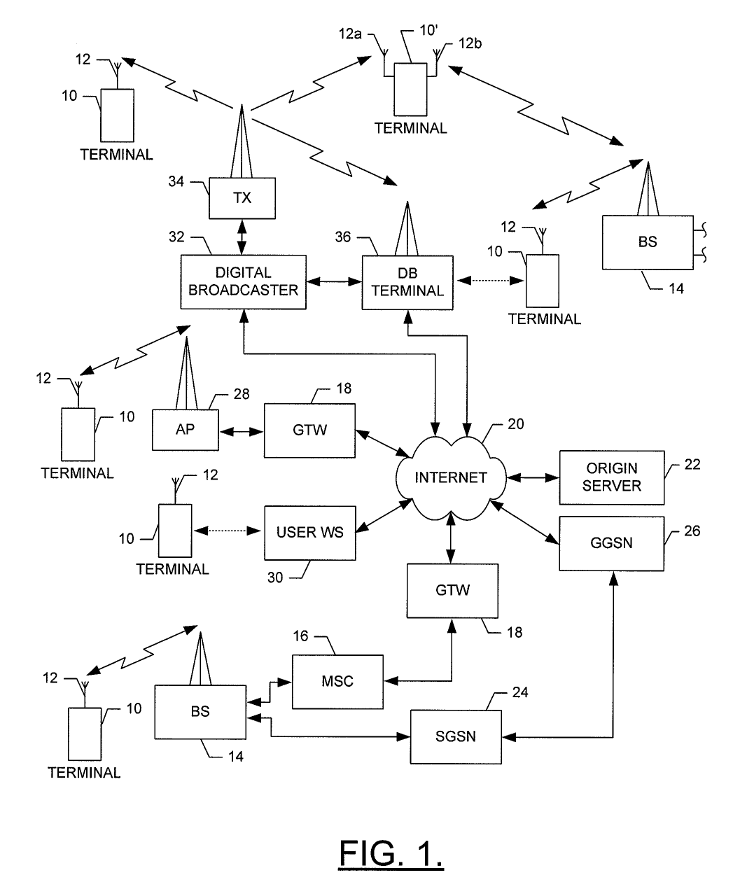

Referring to FIG. 1, an illustration of one type of terminal and system that would benefit from the present invention is provided. The system, method and computer program product of exemplary embodiments of the present invention will be primarily described in conjunction with mobile communications applications. It should be understood, however, that the system, method and computer program product of exemplary embodiments of the present invention can be utilized in conjunction with a variety of other applications, both in the mobile communications industries and outside of the mobile communications industries. For example, the system, method and computer program product of exemplary embodiments of the present invention can be utilized in conjunction with a number of different media playback devices, including dedicated playback devices (e.g., MP3 players, video players, etc.) and/or non-dedicated playback devices (e.g., personal computers, laptop computers, etc.).

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI). In operation, the MSC is configured to route calls and messages to and from the terminal when the terminal is making and receiving calls. The MSC also provides a connection to landline trunks when the terminal is involved in a call.

The MSC 16 can be coupled to one or more data networks, such as one or more local area networks (LANs), metropolitan area networks (MANs), and/or wide area networks (WANs). The MSC can be directly coupled to the data network. In one typical embodiment, however, the MSC is coupled to a server gateway (GTW) 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with one or more origin servers 22 or the like, one of which being illustrated in FIG. 1.

In addition to or in lieu of the cellular network, the BS 14 may be part of a packet-switched core network, such as a GPRS core network. In this regard, the BS may be coupled to a signaling GPRS (General Packet Radio Service) support node (SGSN) 24. As known to those skilled in the art, the SGSN is typically configured to perform functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a GTW, such as a GTW GPRS support node (GGSN) 26, and the GGSN is coupled to the Internet.

By coupling the SGSN 24 to the GGSN 26, devices such as origin servers 22 can be coupled to the terminal 10 via the Internet 20, SGSN and GGSN. In this regard, devices such as origin servers can communicate with the terminal across the SGSN and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

In addition to or in lieu of being coupled to the BS 14, the terminal 10 can be coupled to one or more wireless access points (APs) 28. The APs can comprise access points configured to communicate with the terminal in accordance with techniques such as, for example, radio frequency (RF), Bluetooth (BT), infrared (IrDA) or any of a number of different wireless networking techniques, including WLAN techniques. Additionally, or alternatively, the terminal can be coupled to one or more user workstations (WS) 30. Each user workstation can comprise a computing system such as personal computers, laptop computers or the like. In this regard, the user workstations can be configured to communicate with the terminal in accordance with techniques such as, for example, RF, BT, IrDA or any of a number of different wireline or wireless communication techniques, including LAN and/or WLAN techniques. One or more of the user workstations can additionally, or alternatively, include a removable memory configured to store content, which can thereafter be transferred to the terminal.

The APs 28 and the workstations 30 may be coupled to the Internet 20. Like with the MSC 16, the APs and workstations can be directly coupled to the Internet. In one advantageous embodiment, however, the APs are indirectly coupled to the Internet via a GTW 18. As will be appreciated, by directly or indirectly connecting the terminals and the origin server 22, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data configured to be transmitted, received and/or stored in accordance with exemplary embodiments of the present invention. This content may include, for example, media content with audio, video, textual and/or graphical portions. Thus, use of any such terms should not be taken to limit the spirit and scope of the present invention.

Further, the terminal 10 can additionally, or alternatively, be coupled to one or more digital broadcasters 32 via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 34, such as a DVB TX. Similarly, the terminal can include a receiver, such as a DVB receiver (not shown). The terminal can be configured to receive content from any of a number of different entities in any one or more of a different number of manners. In one embodiment, for example, the terminal can comprise a terminal 10′ configured to transmit and/or receive data, content or the like in accordance with a DVB (e.g., DVB-T, DVB-H, etc.) technique as well as a cellular (e.g., 1G, 2G, 2.5G, 3G, etc.) communication technique. In such an embodiment, the terminal 10′ may include an antenna 12a for receiving content from the DVB TX, and another antenna 12b for transmitting signals to and for receiving signals from a BS 14. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 32 via the TX 34, the terminal can be coupled to a digital broadcast (DB) receiving terminal 36 which, in turn, can be coupled to the digital broadcaster 32, such as directly and/or via the TX. In such instances, the digital broadcast receiving terminal can comprise a DVB receiver, such as a DVB receiver in the form of a set top box. The terminal can be locally coupled to the digital broadcast receiving terminal, such as via a personal area network. In one advantageous embodiment, however, the terminal can additionally or alternatively be indirectly coupled to the digital broadcast receiving terminal via the Internet 20.

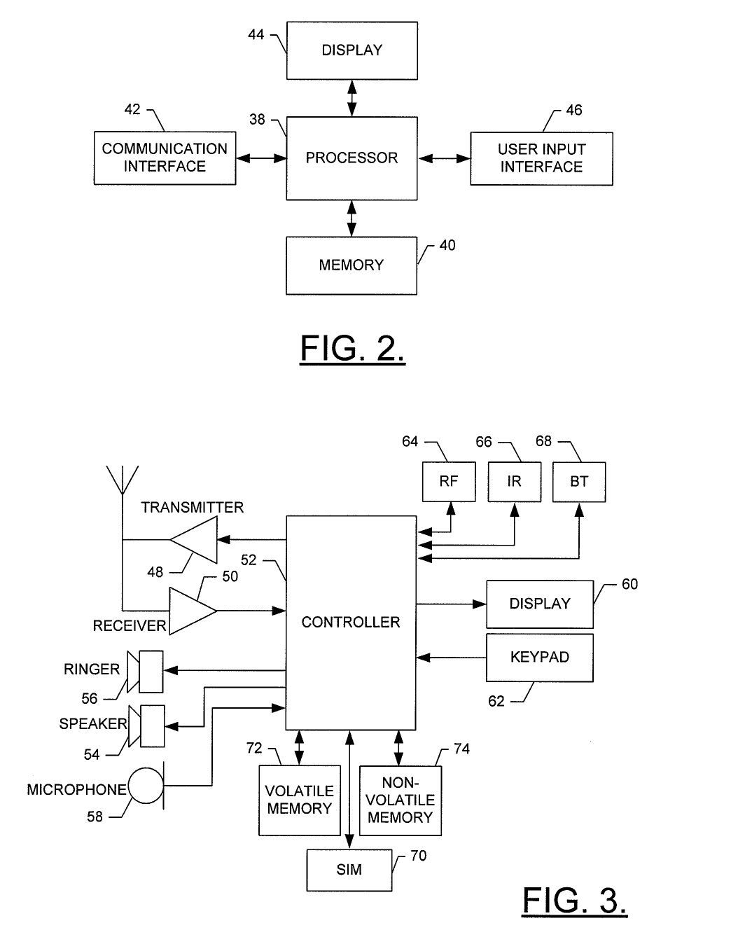

Referring now to FIG. 2, a block diagram of an entity configured to operate as one or more of a terminal 10, origin server 22, workstation 30, digital broadcaster 32, or digital broadcast receiving terminal 36 is shown in accordance with one embodiment of the present invention. Although shown as separate entities, in some embodiments, one or more entities may support one or more of a terminal, origin server, workstation, digital broadcaster or digital broadcast receiving terminal, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

The entity configured to operate as one or more of a terminal 10, origin server 22, workstation 30, digital broadcaster 32, or digital broadcast receiving terminal 36 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 38 connected to a memory 40. The memory can comprise volatile and/or non-volatile memory. The non-volatile memory may comprise embedded and/or may be removable non-volatile memory, and may include, for example, embedded or removable multimedia memory cards (MMCs), Memory Sticks manufactured by Sony Corporation, EEPROM, flash memory, hard disk or the like. The memory typically stores content, data or the like. For example, the memory typically stores content transmitted from, and/or received by, the entity. Also for example, the memory typically stores software applications, instructions or the like for the processor to perform functions associated with operation of the entity in accordance with exemplary embodiments of the present invention. Further for example, and as explained below, the memory can store one or more media playback applications for playing one or more pieces of media, such as one or more pieces of video, music or the like. And to store the pieces of media, the memory can store one or more media databases.

Although described herein as being implemented in software application(s), it should be understood that any one or more of the functions described herein may alternatively be implemented in firmware or hardware, without departing from the spirit and scope of the present invention. Generally, then, the terminal 10, origin server 22, workstation 30, digital broadcaster 32, or digital broadcast receiving terminal 36 can include one or more logic elements for performing various functions. As will be appreciated, the logic elements can be embodied in any of a number of different manners. In this regard, the logic elements performing the respective functions can be embodied in an integrated circuit assembly including one or more integrated circuits integral or otherwise in communication with a respective network entity (i.e., terminal, origin server, digital broadcast receiving terminal, digital broadcaster, etc.) or more particularly, for example, a processor 38 of the respective network entity. The design of integrated circuits is by and large a highly automated process. In this regard, complex and powerful software tools are available for converting a logic level design into a semiconductor circuit design ready to be etched and formed on a semiconductor substrate. These software tools automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 40, the processor 38 can also be connected to at least one interface or other means for displaying, transmitting and/or receiving data, content or the like. In this regard, the interface(s) can include at least one communication interface 42 or other means for transmitting and/or receiving data, content or the like, as well as at least one user interface that can include a display 44 and/or a user input interface 46. The user input interface, in turn, can comprise any of a number of devices allowing the entity to receive data from a user, such as a keypad, a touch display, a joystick or other input device. As more particularly explained below, for example, the user input interface can include one or more directional keys (hard and/or soft keys) for directionally selecting ordered items, such as ordered channels of content.

FIG. 3 illustrates a more particular functional block diagram of a terminal 10, according to exemplary embodiments of the invention. It should be understood, that the terminal illustrated and hereinafter described is merely illustrative of one type of terminal that would benefit from the present invention and, therefore, should not be taken to limit the scope of the present invention. While several embodiments of the terminal are illustrated and will be hereinafter described for purposes of example, other types of terminals, such as portable digital assistants (PDAs), pagers, laptop computers, media players and other types of voice and text communications systems, can readily employ the present invention.

The terminal 10 includes various means for performing one or more functions in accordance with exemplary embodiments of the present invention, including those more particularly shown and described herein. It should be understood, however, that the terminal may include alternative means for performing one or more like functions, without departing from the spirit and scope of the present invention. More particularly, for example, as shown in FIG. 3, the terminal may include a transmitter 48, a receiver 50, and a controller 52 or other processor that provides signals to and receives signals from the transmitter and receiver, respectively. These signals include signaling information in accordance with the air interface standard of the applicable cellular system, and also user speech and/or user generated data. In this regard, the terminal can be configured to operate with one or more air interface standards, communication protocols, modulation types, and access types. More particularly, the terminal can be configured to operate in accordance with any of a number of first-generation (1G), second-generation (2G), 2.5G and/or third-generation (3G) communication protocols or the like. For example, the terminal may be configured to operate in accordance with 2G wireless communication protocols IS-136 (TDMA), GSM, IS-95 (CDMA) or the like. Also, for example, the terminal may be configured to operate in accordance with 2.5G wireless communication protocols GPRS, Enhanced Data GSM Environment (EDGE), or the like. The terminal can additionally or alternatively be configured to operate in accordance with any of a number of different digital broadcasting techniques, such as the DVB technique (e.g., DVB-T, ETSI Standard EN 300 744). The terminal can also be configured to operate in accordance with any of a number of different broadcast and/or multicast techniques, such as the MBMS technique (e.g., 3GPP TS 22.146). Further, the terminal can be configured to operate in accordance with ISDB-T, DAB, ATSC techniques or the like. Some narrow-band AMPS (NAMPS), as well as TACS, terminals may also benefit from embodiments of the present invention, as should dual or higher mode terminals (e.g., digital/analog or TDMA/CDMA/analog phones).

It is understood that the controller 52 includes the circuitry required for implementing the audio and logic functions of the terminal. For example, the controller may be comprised of a digital signal processor device, a microprocessor device, and various analog to digital converters, digital to analog converters, and other support circuits. The control and signal processing functions of the terminal are allocated between these devices according to their respective capabilities. The controller thus also includes the functionality to convolutionally encode and interleave message and data prior to modulation and transmission. The controller can additionally include an internal voice coder (VC), and may include an internal data modem (DM). Further, the controller may include the functionally to operate one or more software applications, which may be stored in memory.

The terminal also comprises a user interface including a conventional earphone or speaker 54, a ringer 56, a microphone 58, a display 60, and a user input interface, all of which are coupled to the controller 52. The user input interface, which allows the terminal to receive data, can comprise any of a number of devices allowing the terminal to receive data, such as a keypad 62, a touch display (not shown) or other input device. In embodiments including a keypad, the keypad includes the conventional numeric (0-9) and related keys (#, *), and other keys used for operating the terminal. For example, the keypad can additionally or alternatively include directional keys (↑, →, ↓, ←) for directionally scrolling and/or selecting ordered items.

The terminal can also include one or more means for sharing and/or obtaining data from electronic devices, such as another terminal 10, an origin server 22, an AP 28, a digital broadcast receiving terminal 36, a digital broadcaster 32 or the like, in accordance with any of a number of different wireline and/or wireless techniques. For example, the terminal can include a radio frequency (RF) transceiver 64 and/or an infrared (IR) transceiver 66 such that the terminal can share and/or obtain data in accordance with radio frequency and/or infrared techniques. Also, for example, the terminal can include a Bluetooth (BT) transceiver 68 such that the terminal can share and/or obtain data in accordance with Bluetooth transfer techniques. Although not shown, the terminal may additionally or alternatively be configured to transmit and/or receive data from electronic devices according to a number of different wireline and/or wireless networking techniques, including LAN and/or WLAN techniques. In this regard, as shown in FIG. 1 with respect to terminal 10′, the terminal may include an additional antenna or the like to transmit and/or receive data from such electronic devices (e.g., digital broadcaster).

The terminal can further include memory, such as a subscriber identity module (SIM) 70, a removable user identity module (R-UIM) or the like, which typically stores information elements related to a mobile subscriber. In addition to the SIM, the terminal can include other memory, such as volatile memory 72, and/or other non-volatile memory 74 (embedded and/or may be removable non-volatile memory). For example, the other non-volatile memory can comprise embedded or removable multimedia memory cards (MMCs), Memory Sticks manufactured by Sony Corporation, EEPROM, flash memory, hard disk or the like.

The memories 70, 72, 74 can store any of a number of pieces of information, and data, used by the terminal to implement the functions of the terminal. For example, the memories can store an identifier, such as an international mobile equipment identification (IMEI) code, uniquely identifying the terminal, such as to the MSC 16. The memories can also store one or more media playback applications, and one or more media databases, such as those mentioned above and explained below.

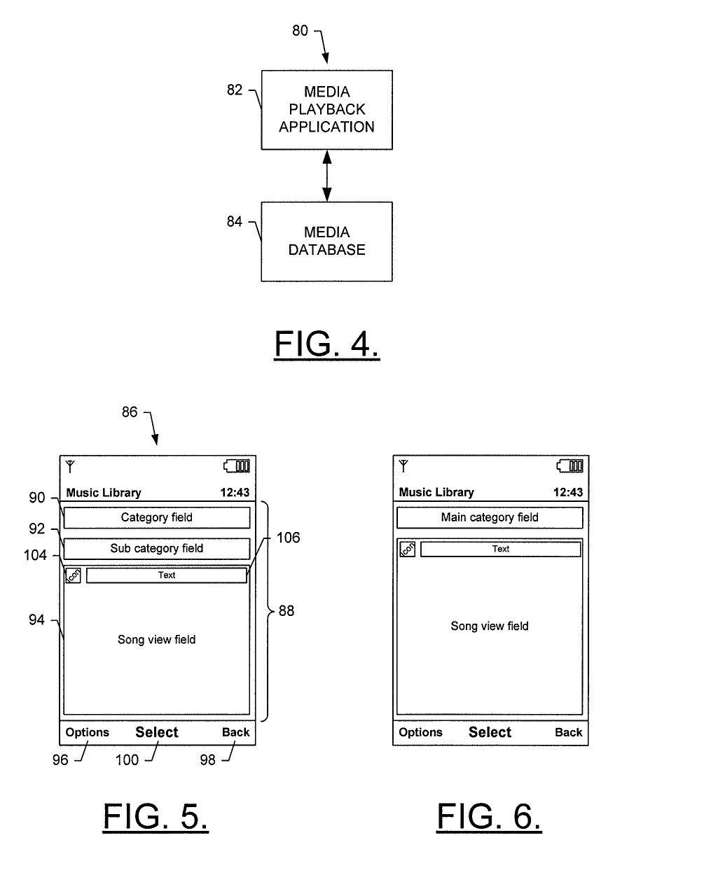

In one or more configurations, a terminal 10, origin server 22, workstation 30, digital broadcaster 32, or digital broadcast receiving terminal 36 may include a media database with a number of pieces of media content. In such instances, a user of the apparatus may desire to organize, browse and access one or more of the pieces of media content in the respective database in a convenient manner. Referring now to the functional block diagram of FIG. 4, exemplary embodiments of the present invention therefore provide an apparatus 80 including one or more media playback applications 82 for browsing and accessing one or more pieces of media from one or more media databases 84, libraries or the like. As shown and described herein, the apparatus may comprise any of a number of different apparatuses configured to operate in accordance with exemplary embodiments of the present invention, including for example, a terminal, origin server, workstation, digital broadcaster, or digital broadcast receiving terminal. As also shown and described herein, the media that may be browsed and accessed from the media playback application, and that is stored in the media database may comprise any of a number of types of media, as indicated above. In a more particular example shown and described herein, for example, the media may comprise song tracks, video files, Internet streams (audio and/or video), files or the like. Further, although shown and described as being stored in the media database, one or more pieces of media content may instead be stored remote from the apparatus. In such instances, the database may instead store references to the respective pieces of media content.

The pieces of media content stored (or referenced) in the database 84 of the apparatus 80 may be associated one or more criterion or other characterizing mark or trait. In the context of music media, for example, the pieces of media content may include particular values of the criteria including one or more of “Artist,” “Genre,” “Composer,” “Album” or “Playlists.” These criteria and their particular values may be associated with the media content in any of a number of different manners, such as via metadata associated with the respective pieces of media content, one or more files and/or tables associated with the respective criteria, or the like.

The playback application 82 of the apparatus 80 is configured to present, in a display (e.g., display 44, display 60) of the apparatus, a graphical user interface (GUI) from which a user of the apparatus may direct operation of the playback application. Operation of the playback application may include, for example, downloading or otherwise receiving one or more pieces of media content, which may then be stored or otherwise referenced in the database 84. Additionally or alternatively, for example, operation of the playback application may include altering the media content stored (or referenced) in the database, such as by deleting one or more pieces of media content, and/or altering one or more criterion associated with one or more pieces of content (e.g., adding, deleting and/or modifying one or more playlists including one or more pieces of media content). And as further explained below, operation of the playback application may include browsing or otherwise navigating the media content stored (or referenced) in the database, and receiving selection of one or more pieces of media content for play by the playback application. It should be understood, however, that one or more functions of the playback application may alternatively be performed by one or more other applications in communication with the playback application. For example, while the playback application may present GUI displays to enable a user to browse and select media content, another application in communication with the playback application may actually play the selected media content.

Reference is now made to FIGS. 5-12, which illustrate various views of the GUI 86 presented by the playback application 82 of exemplary embodiments of the present invention. As shown, the GUI may fill a window area 88 and include, in the window area, one or more fields such as a category field 90, a subcategory field 92 and a media content (e.g., song view) field 94. The fields are configured to include information related to media content, and depending on the media content included in a field, may be scrollable. In this regard, the GUI may be configured to display, simultaneously and in a single window area, a number of different types of information related to media content and from which that media content may be accessed. This type of configuration may be particularly useful as compared to GUI configurations whereby different types of information are displayed in separate GUI windows or displays in a sequential manner.

The category and subcategory fields 90, 92 may be scrollable left and right (horizontally), and may wrap around the display, to accommodate information greater than that which will fit in the display (e.g., display 44, display 60) of the apparatus. Similarly, for example, the media content field may be scrollable up and down (vertically), and/or left and right, and may wrap around the display, to accommodate information greater than that which will fit in the display of the apparatus. In this regard, one or more of the fields may be scrolled in response to actuation of directional keys (↑, →, ↓, ←) of a user input interface (e.g., interface 46) or more particularly, for example, a keypad (e.g., keypad 62) of the apparatus. Additionally or alternatively, one or more of the fields may be scrolled to particular content identified therein in response to the user entering one or more letters spelling out the respective content, such as by entering the letter “s” to scroll directly to content beginning with the letter “s.”

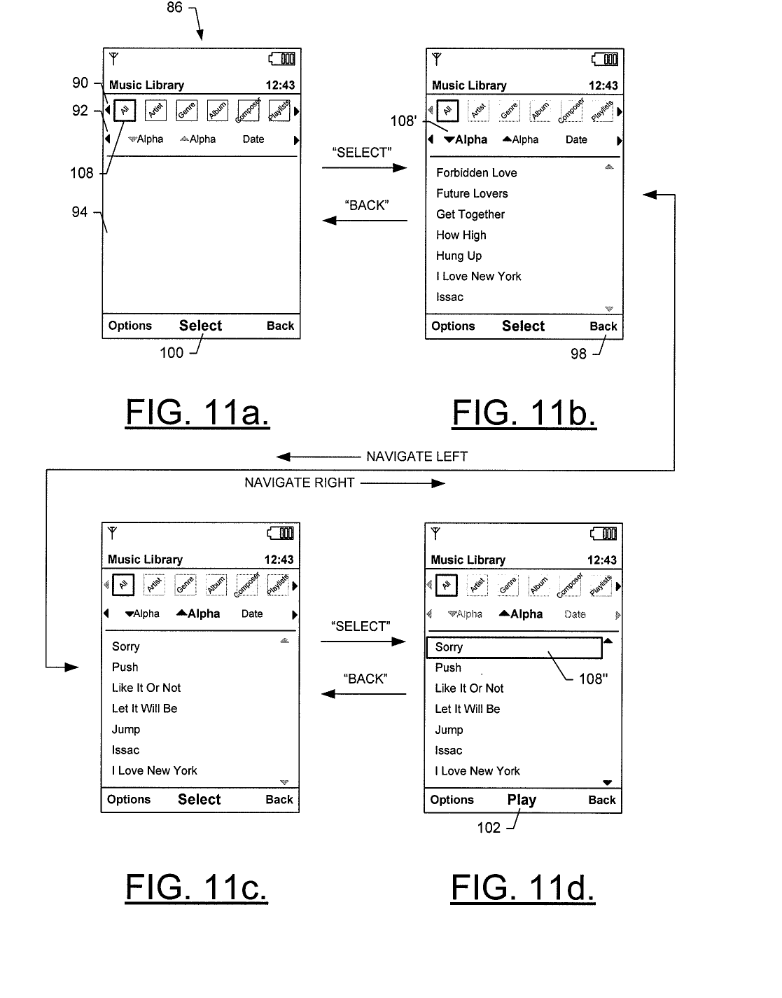

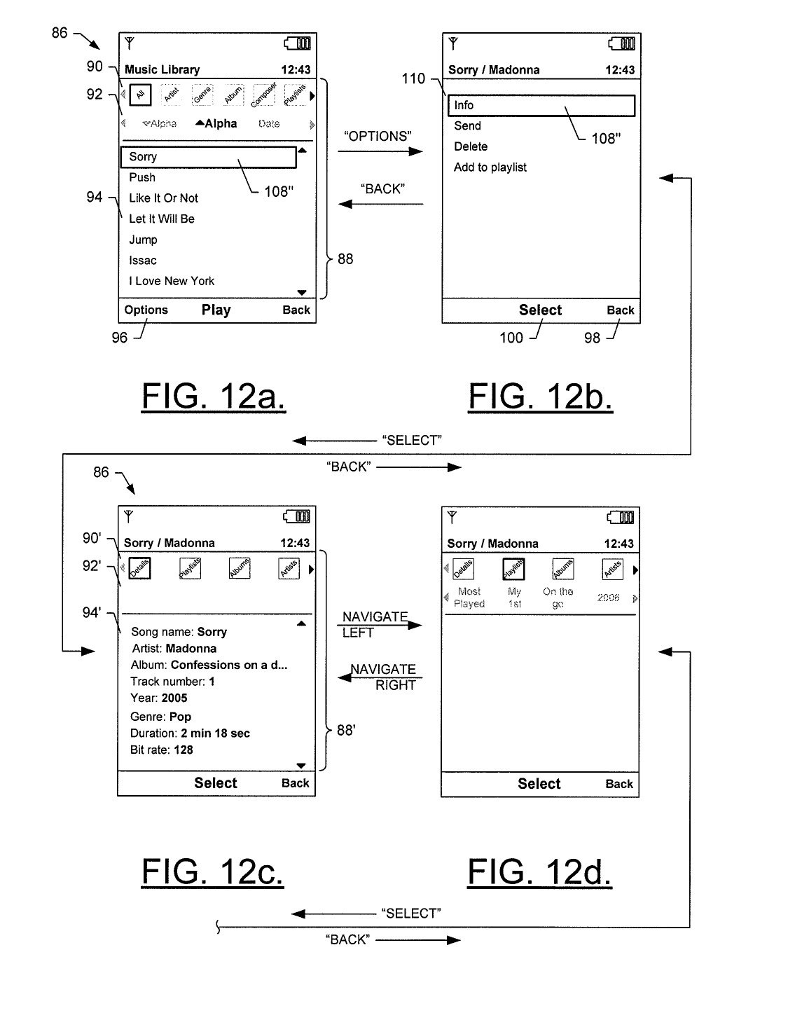

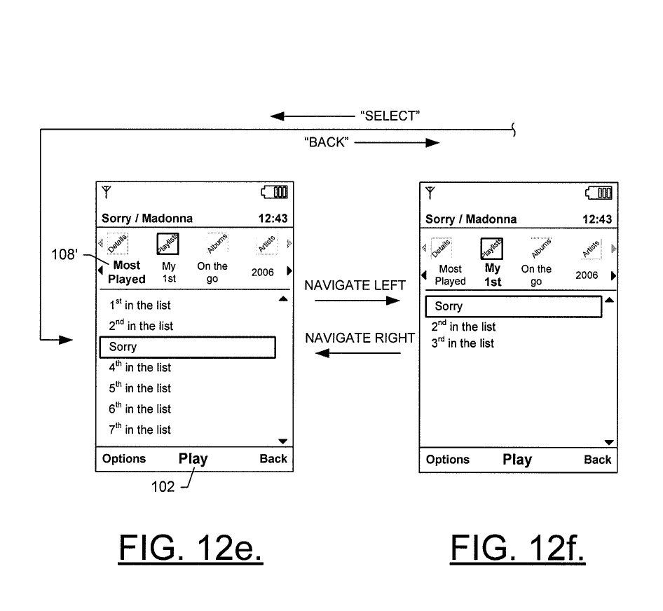

During operation of the playback application 82, the GUI may further include a number of different soft keys for effectuating various functions of the application. These soft keys may change at one or more times during operation of the application during the state of the application and may include, for example, an “Options” key 96, a “Back” key 98, a “Select” key 100, and a “Play” key 102 (see FIGS. 11d, 12a, 12e and 12f).

The category, subcategory and media content fields 90, 92, 94 may include one or more pieces of information related to media content. As shown with respect to the media content field, this information may include icon or other indicia-based information 104, text-based information 106 or the like. Also, during operation, one or more of the fields may not include any information related to media content, and in such instances, the GUI 86 may collapse the respective field(s). This is shown, for example, by comparison of FIGS. 5 and 6 with respect to the subcategory field.

As indicated above, the pieces of media content stored (or referenced) in the database 84 of the apparatus 80 may be associated one or more criterion or other characterizing mark or trait. In the context of music media, for example, the pieces of media content may include particular values of criteria including one or more of “Artist,” “Genre,” “Composer,” “Album” or “Playlists.” Generally, these criteria and their values, and thus the media content itself, may be organized in accordance with a hierarchy including one or more categories, one or more subcategories logically underneath respective one or more categories, one or more sub-subcategories logically underneath respective one or more subcategories, and so forth. The hierarchy may then terminate with one or more pieces of media content associated with one or more respective categories, subcategories, sub-subcategories, and so forth.

More particularly, the criteria “Artist,” “Genre,” “Composer,” “Album” and “Playlists” may be organized as categories, which may include one or more other categories such as “All” (for all media content). Logically underneath each category, then, the values of the respective criteria may be organized as subcategories. Thus, for example, logically underneath the category “Artist,” may be subcategories including “Annie Lennox,” “Christina Aguilera,” “Jay Z.” “Madonna” or the like, each subcategory being associated with media content stored (or referenced) in the database 84 of the apparatus 80. Similarly, logically underneath the category “Genre,” for example, may be subcategories including “Hip Hop,” “Jazz,” “Rock,” “Pop” or the like. Logically underneath the category “Album” may be subcategories including one or more albums associated with media content stored (or referenced) in the database. And logically underneath the category “Playlists” may be subcategories including one or more predefined and/or user defined playlists including media content stored (or referenced in the database).

Additionally or alternatively, logically underneath one or more categories, one or more of the other categories may be organized as subcategories. Thus, for example, at least the category “Genre” may be included as a subcategory logically underneath one or more of the categories “Artist,” “Composer,” “Album” or “Playlists.” Similarly, for example, one or more of the categories “Artist,” “Composer,” “Album” or “Playlists” may be included as a subcategory logically underneath the category “Genre.” Further, logically underneath one or more subcategories (logically underneath respective categories), one or more of the other categories may be organized as sub-subcategories. In one such example, the categories “All” and “Album” may be included as sub-subcategories logically underneath the subcategory “Anne Lennox” (logically underneath the category “Artist”). It should therefore be understood that criteria and their particular values associated with media content may be organized in a hierarchy including any of a number of different levels, and that criteria or values in one level may also be included in one or more other levels of the hierarchy.

As indicated above, the category, subcategory and media content fields 90, 92, 94 of the GUI 86 of exemplary embodiments of the present invention may identify one or more categories, subcategories and pieces of media content, respectively. And although not shown, the GUI may include one or more additional fields for identifying other levels of the hierarchy, such as sub-subcategories. Although reference may be made to arranging and displaying categories, subcategories and pieces of media content, it should be understood that the arrangement and/or display of a category, subcategory or piece of media content may more particularly refer to information identifying a category, subcategory or piece of media content. Again, this information may include, for example, icons or other indicia, textual information or the like.

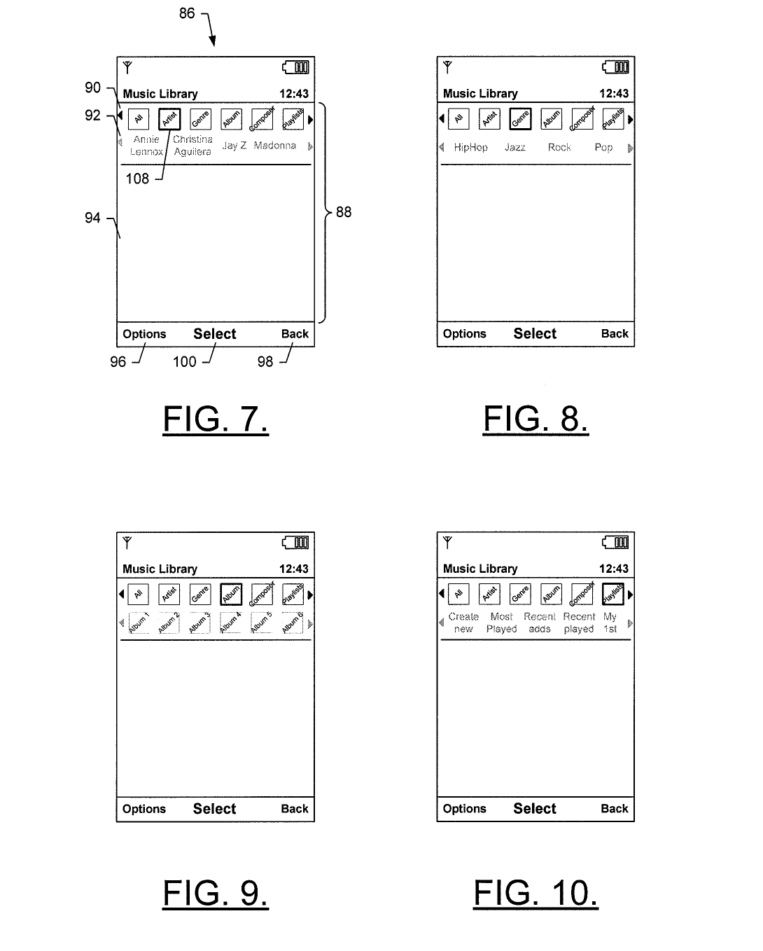

In each field 90, 92, 94, the GUI 86 may further include a frame 108 (see, e.g., FIG. 7) for selecting a category, subcategory, piece of media content or the like within the respective field. The frame may be movable with respect to the identified categories, subcategories or pieces of media content, or alternatively the identified categories, subcategories or pieces of media content may be movable with respect to the frame, to align the frame with a particular category, subcategory or piece of media content to thereby select the particular category, subcategory or piece of media content. In this regard, the frame or identified categories, subcategories or pieces of media content may be moved by the user in any of a number of different manners, such as by actuation of directional keys (↑, →, ↓, ←) of a keypad (e.g., keypad 62) of the apparatus 80, and/or by entering one or more letters spelling out identified categories, subcategories or pieces of media content, as indicated above.

When aligned with a particular category, subcategory or piece of media content, the frame 108 may be displayed and/or applied as a border to the category, subcategory or piece of media content. The frame may further be colored to stand out from the coloring of the categories, subcategories or pieces of media content. Additionally or alternatively, the frame's shape and size may be automatically modified to suit the shape and size of the category, subcategory or piece of media content with which the frame is aligned. In further alternatives, the frame may manifest itself as a change 108′ in one or more of the color, size or shape of the aligned category, subcategory or piece of media content (see, e.g., FIG. 11b), or as a visible shape 108″ underlying or overlaying (e.g., transparently overlaying) the aligned category, subcategory or piece of media.

The category field 90 of the GUI 86 identifies the one or more categories associated with media content stored (or referenced) in the database 84 of the apparatus 80. The subcategory field 92 of the GUI, then, may identify one or more subcategories associated with the respective media content, where the identified subcategories may depend on a category selected or otherwise aligned with the frame 108 in the category field. That is, the subcategory field may identify one or more subcategories that, in the aforementioned hierarchy, are located logically underneath the category selected or otherwise aligned with the frame in the category field. Similarly, the media content field 94 may identify one or more pieces of media content that, in the hierarchy, are located logically underneath a subcategory selected or otherwise aligned with the frame in the subcategory field. It should be recognized, however, that in various instances a category or subcategory may not yet be selected or aligned with a respective frame. In such instances, the subcategory and/or media content fields may identify all subcategories and media content stored (or referenced) in the database. Alternatively, the fields may remain empty until a category or subcategory is selected or otherwise aligned with a respective frame. In such instances, one or both of the subcategory or media content fields may be collapsed until such time as a category or subcategory is selected or aligned with the frame, as indicated above.

More particularly with reference to FIGS. 7-11, the category field 90 of the GUI 86 identifies the one or more categories associated with media content stored (or referenced) in the database 84 of the apparatus 80. As shown, a particular category in the category field is selected or otherwise aligned with the frame 108 in the category field, and as such, the subcategory field 92 identifies subcategories associated with the respective media content, and logically underneath the selected or otherwise aligned category in the hierarchy. More particularly, for example, in FIG. 7, the category “Artist” is aligned with the frame in the category field 90, thereby driving the subcategory field 92 to identify artists (subcategories) logically underneath the “Artist” category in the hierarchy. As shown in FIG. 8, the category “Genre” is aligned with the frame in the category field, thereby driving the subcategory field to identify genres (subcategories) logically underneath the “Genre” category in the hierarchy. In FIG. 9, the category “Album” is aligned with the frame in the category field, thereby driving the subcategory field to identify albums (subcategories) logically underneath the “Album” category in the hierarchy.

In FIG. 10, the category “Playlists” is aligned with the frame 108 in the category field 90, thereby driving the subcategory field 92 to identify playlists (subcategories) logically underneath the “Playlists” category in the hierarchy. Further, in instances in which the category “Playlists” is aligned with the frame in the category field, the subcategory field may further identify one or more functions of the playback application 82 with respect to adding, deleting or otherwise modifying playlists. As described herein, these functions may at times be more generically referred to as subcategories. These function(s), such as “Create new,” may be selected in a manner similar to the subcategories in the subcategory field. In response to selection of a function, however, the GUI of the playback application may present one or more displays for carrying out the respective function (not shown).

Reference is now made to FIGS. 11a-11d, which illustrate various exemplary displays of the GUI 86 during operation of the playback application 82. The displays shown in and described with reference to FIGS. 11a-11d relate to selection of the category “All.” It should be understood, however, that similar displays may be presented in response to selection of other categories, although some distinctions between displays may be noted below.

As shown in FIG. 11a, in operation and as indicated above, the category field 90 of the GUI 86 identifies the one or more categories associated with media content stored (or referenced) in the database 84 of the apparatus 80. As shown, for example, the category “All” is aligned with the frame 108 in the category field. In such instances, the GUI may collapse the subcategory field, and drive the media content field 94 to identify all of the stored (or referenced) media content. Alternatively, as shown, the GUI may drive the subcategory field 92 to identify one or more options for the presentation of pieces of media content in the media content field. Similar to functions identified in the subcategory field, as described herein, these options may at times be more generically referred to as subcategories. As shown, these options may include, for example, presenting the pieces of media content decreasing or increasing alphabetical order (e.g., by name), by date (e.g., date created, added to the database, etc.) or the like.

To navigate the category field 90 to select a desired category, the frame 108 of the category field may be moved left or right, such as via directional keys (→, ←), to sequentially align the frame with various ones of the identified categories until the frame comes into alignment with the desired category. As the frame is aligned with the desired category or another category during navigation to the desired category, the subcategory field 92 of the GUI may identify one or more subcategories for the currently-aligned category. However, fields other than the field currently being navigated by the user, including in this instance the subcategory field, may be considered inactive (the currently-navigated filed being considered the active field). And while the information may be displayed in one or more inactive fields, the GUI may at least temporarily render the respective information un-selectable, such as by “graying out” the respective information, as shown. In this regard, information may be grayed out in a number of different ways, including by altering one or more of the color (e.g., muting color), size (e.g., decreasing size), intensity (e.g., decreasing intensity) or transparency (e.g., increasing transparency) of the respective information.

Once the frame 108 is aligned with the desired category in the category field 90 of the GUI 86, the desired category may be selected by the user, such as by actuating the “Select” soft key 100. In response to selecting the desired category, the GUI may navigate down to or otherwise activate the subcategory field 92 which, as indicated above, may identify one or more subcategories associated with the selected category. Similar to navigating the category field, to navigate the subcategory field to select a desired subcategory, the frame 108′ of the subcategory field may be moved left or right, such as via directional keys (→, ←), to sequentially align the frame with various ones of the identified subcategories until the frame comes into alignment with the desired subcategory, as shown in FIGS. 11b and 11c.

As the user navigates the subcategories in the subcategory field 92, it may be desirable for the user to navigate back up to the category field 90 such as to select a different desired category. As shown, the user may navigate up to the category field by actuating the “Back” soft key 98. Then, in response to actuation of the “Back” soft key, the GUI may return the user to navigating the category field, with the remaining fields being displayed in a manner similar to before.

Similar to before, as the frame 108′ is aligned with a subcategory, whether the desired subcategory or another subcategory during navigation to the desired subcategory, the media content field 94 may identify one or more pieces of media content associated with or otherwise in accordance with the currently-aligned subcategory. As shown, for example, when the frame is aligned with an option for displaying pieces of media content in decreasing alphabetical order, the media content field may identify one or more, or even all, pieces of media content in this manner. Again, fields other than the field currently being navigated by the user, now including both the category and media content fields, may be considered inactive (the currently-navigated filed being considered the active field). Further, while the information may be displayed in one or more inactive fields, the GUI may at least temporarily render the respective information un-selectable, such as by graying out the respective information. In various instances, however, the selected category may be displayed as before, with the other categories being grayed out.

As explained above, as the user navigates the subcategory field 92, the media content field 94 may identify pieces of media content but render those pieces of media content un-selectable until a subcategory is selected. In various instances, however, both the subcategory field and the media content field may be simultaneously active and navigable. In one such instance, for example, one set of keys (e.g., directional keys (→, ←)) may be used to navigate the subcategory field, while another set of keys (e.g., directional keys (↑, ←)) may be used to navigate the media content field.

Within the subcategory field 92 of the GUI 86, once the frame 108′ is aligned with the desired subcategory, the desired subcategory may be selected by the user, such as by actuating the “Select” soft key 100 in a manner similar to selection of the desired category. In response to selecting or otherwise aligning the frame with the desired subcategory, the GUI may continue to operate based on the respective subcategory. More particularly, for example, in response to selection or alignment of a function, the GUI may present one or more displays for carrying out the respective function (not shown). Also, for example, in response to selection or alignment of a subcategory, the GUI may navigate down to or otherwise activate the media content field 94 which, as indicated above, may identify one or more pieces of media content associated with the respective subcategory. Similarly, for example, in response to selection or alignment of an option, the GUI may navigate down to or otherwise activate the media content field, which as shown in FIG. 11d for example, may identify one or more pieces of media content in accordance with the selected option, such as by identifying piece(s) of content in increasing alphabetical order.

Similar to the other fields, once activated by the GUI 86, the user may navigate the media content field 94 to select a desired piece of media content by moving (or rather, directing movement of) the frame 108″ of the media content field up or down, such as via directional keys (↑, ←), to sequentially align the frame with various ones of the identified pieces of media content until the frame comes into alignment with the desired piece of media content. Alternatively, the user may navigate back up to the subcategory field 92, such as by actuating the “Back” soft key 98 to direct the GUI to return the user to navigating the subcategory field, with the remaining fields being displayed in a manner similar to before. Should the user desire to navigate the media content field to a desired piece of media content, however, once the frame is aligned with the desired piece of media content, the desired piece of media content may be selected for play by the playback application 82, such as by actuating the “Play” soft key 102. In response to selecting the desired piece of media content for play, the GUI may present a player GUI including one or more functions for controlling play of the piece of media content, such as play, stop, pause, rewind, fast forward, or the like.

In various instances, before or lieu of selecting the desired piece of media content for play by the playback application 82, the user may review and/or edit criteria associated with the desired piece of content or direct performance of one or more other functions with respect to the desired piece of content. Reference is now made to FIGS. 12a-12f, which illustrate various exemplary views of the GUI 86 for reviewing and/or directing the playback application 82 to perform one or more functions with respect to a desired piece of content. With reference to FIG. 12a, again, once the frame 108″ is aligned with the desired piece of media content, the desired piece of media content may be selected for reviewing and/or editing its criteria, and/or for directing performance of one or more functions with respect thereto, such as by actuating the “Options” key 96.

As shown in FIG. 12b, in response to selecting the desired piece of media content for reviewing and/or editing its criteria, and/or for directing performance of function(s) with respect thereto, the GUI 86 may present a listing 110 of options with respect to the selected piece of content, and presenting a frame 108″ for selecting a particular option. As shown, these options may include, for example, an option to review and/or edit criteria for the piece of content (e.g., “Info”), an option to send the piece of content such as to a recipient device remote from the apparatus 80 (e.g., “Send”), an option to delete the piece of content from the database 84 (e.g., “Delete”), or an option to add the selected piece of media content to a new or existing playlist (e.g., “Add to playlist”). A further option may include, for example, an option to add one or more criteria or “tags” to the selected piece of media content, such as to enable browsing media content by those added criteria or tags.

Similar to the other displays, once presented by the GUI 86, the user may navigate the options list 110 to select a desired option by moving (or rather, directing movement of) the frame 108″ up or down, such as via directional keys (↑, ↓), to sequentially align the frame with various ones of the identified options until the frame comes into alignment with the desired option. Alternatively, the user may navigate back to the previous display including the window 88 and its fields 90, 92 and 94 (see, e.g., FIG. 12a), such as by actuating the “Back” soft key 98. Should the user desire to navigate the options list to a desired option, however, once the frame is aligned with the desired option, the desired option may be selected, such as by actuating the “Select” soft key 100.

In response to selecting the desired option, the playback application 82 may perform one or more functions to carry out the respective option, which may include the GUI 86 presenting one or more further displays. As shown in FIG. 12c, for example, in instances in which an option to review and/or edit criteria for the piece of content (e.g., “Info”) is selected, the GUI may display a second window area 88′ (e.g., replacing the above-described, first window area 88) including one or more fields such as a second category field 90′, a second subcategory field 92′ and a second media content field 94′ (in relation to a first category field 90, first subcategory field 92 and first media content field 94, respectively). As explained below, these second category, subcategory and media content fields may be navigated in a manner similar to the first category, subcategory and media content fields.

The second category, subcategory and media content fields 90′, 92′, 94′ may include one or more pieces of information related to the currently-selected piece of media content. Similar to the first category field 90, the second category field of the GUI 86 may identify one or more categories with which the currently-selected piece of media content is associated. As shown, for example, the second category field may identify categories “Details” (for details regarding the currently-selected piece of media content), as well as one or more of the aforementioned categories including “Playlists,” “Albums” and “Artists.” As shown, a particular category in the second category field is selected or otherwise aligned with the frame 108 in the second category field, and as such, the second subcategory field 92′ identifies any subcategories with which the currently-selected piece of media content may be associated, and logically underneath the selected or otherwise aligned category in the hierarchy. In various instances, the currently-selected piece of media content is not associated with any subcategories logically underneath the selected or otherwise aligned category, as shown for example in FIG. 12c whereby the category “Details” is aligned with the frame in the second category field. In such instances, the GUI may collapse the subcategory field or otherwise leave the subcategory field, and may drive the second media content field to identify detailed information related to the currently-selected piece of media content. In the case of music media, for example, this detailed information may include, for example, one or more of the song name, artist, album, track number, year, genre, duration, or bit rate.

Having navigated right from the category “Details” in the second category field 90′), for example, when the category “Albums” is aligned with the frame 108 in the second category field 90′, the GUI 86 may be driven to identify, in the second subcategory field 92′, albums (subcategories) including the currently-selected piece of media content (or with which the currently-selected piece of media content is associated), and logically underneath the “Albums” category in the hierarchy. Once the frame 108 is aligned with the respective, desired category, the desired category may be selected by the user, such as by actuating the “Select” soft key 100. In response to selecting the desired category, the GUI may navigate down to or otherwise activate the subcategory field 92. The user may then navigate the subcategory field to select a desired album including the currently-selected piece of media content, such as by moving the frame 108′ of the subcategory field left or right, such as via directional keys (→, ←), to sequentially align the frame with various ones of the identified subcategories until the frame comes into alignment with the desired subcategory. Alternatively, the user may navigate back up to the second category field 92′, such as by actuating the “Back” soft key 98.

Also, for example, having navigated right from the category “Details” in the second category field 90′, when the category “Artists” is aligned with the frame 108 in the second category field 90′, the GUI 86 may be driven to identify, in the second subcategory field 92′, artists (subcategories) with which the currently-selected piece of media content is associated, and logically underneath the “Artists” category in the hierarchy. Again, once the frame 108 is aligned with the respective, desired category, the desired category may be selected by the user, such as by actuating the “Select” soft key 100. In response to selecting the desired category, the GUI may navigate down to or otherwise activate the subcategory field 92. The user may then navigate the subcategory field to select a desired artist associated with currently-selected piece of media content, such as by moving the frame 108′ of the subcategory field left or right, such as via directional keys (→, ←), to sequentially align the frame with various ones of the identified subcategories until the frame comes into alignment with the desired subcategory. Alternatively, the user may navigate back up to the second category field 92′, such as by actuating the “Back” soft key 98.

Further, for example, as shown in FIG. 12d (and, yet again, having navigated right from the category “Details” in the second category field 90′), for example, the category “Playlists” is aligned with the frame 108 in the second category field 90′. In this instance, aligning the second category field with the “Details” category may drive the GUI 86 to identify, in the second subcategory field 92′, playlists (subcategories) including the currently-selected piece of media content (or with which the currently-selected piece of media content is associated), and logically underneath the “Playlists” category in the hierarchy. In instances in which the user desires to select the “Playlists” category, once the frame 108 is aligned with the respective, desired category, the desired category may be selected by the user, such as by actuating the “Select” soft key 100. In response to selecting the desired category, the GUI may navigate down to or otherwise activate the subcategory field 92. The user may then navigate the subcategory field to select a desired playlist including the currently-selected piece of media content, such as by moving the frame 108′ of the subcategory field left or right, such as via directional keys (→, ←), to sequentially align the frame with various ones of the identified subcategories until the frame comes into alignment with the desired subcategory, as shown in FIGS. 12e and 12f. Alternatively, the user may navigate back up to the second category field 92′, such as by actuating the “Back” soft key 98.

Similar to before, and as shown in FIGS. 12e and 12f, as the frame 108′ is aligned with a particular playlist (subcategory) including the currently-selected piece of media content, the second media content field 94′ may identify the one or more pieces of media content associated with the currently-aligned playlist, including the currently-selected piece of media content. Within the second subcategory field 92′ of the GUI 86, once the frame 108′ is aligned with the desired subcategory, the desired subcategory may be selected by the user, such as by actuating the “Select” soft key 100 in a manner similar to selection of the desired category. In response to selecting or otherwise aligning the frame with the desired subcategory, the GUI may continue to operate based on the respective subcategory. More particularly, for example, in response to selection or alignment of a particular playlist (subcategory), the GUI may navigate down to or otherwise activate the second media content field 94′, which in the context of playlists, as indicated above, may identify one or more pieces of media content associated with the respective playlist (including the currently-selected piece of media content).

In the context of having selected or otherwise aligned the frame 108′ with a desired playlist in the second subcategory field 92′, once activated by the GUI 86, the user may navigate the second media content field 94′ to select a desired piece of media content, whether the currently-selected piece of media content or another piece of media content. Once the frame is aligned with the desired piece of media content, the desired piece of media content may be selected for play by the playback application 82, such as by actuating the “Play” soft key 102. In response to selecting the desired piece of media content for play, the GUI may present the player GUI including one or more functions for controlling play of the piece of media content, such as play, stop, pause, rewind, fast forward, or the like.

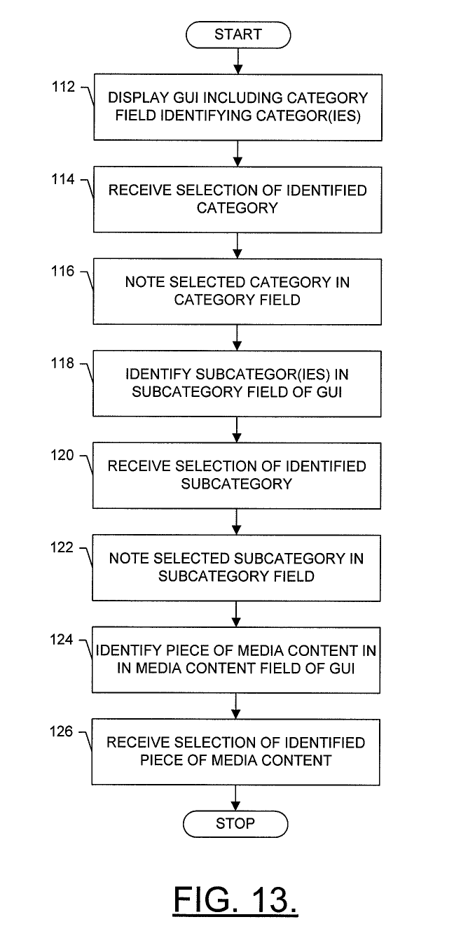

Reference is now made to the flowchart of FIG. 13, which illustrates various steps in a method of accessing a piece of media content or information related thereto, according to one exemplary embodiment of the present invention. As shown in block 112, the method of this exemplary embodiment includes displaying the graphical user interface (GUI) 86 of an apparatus 80. The GUI fills a window area 88 and includes a category field 90, a subcategory field 92 and a media content field 94. The category field identifies therein one or more categories associated with one or more pieces of media content. In this regard, the categories are included in a hierarchy including one or more subcategories logically underneath respective categories, and one or more pieces of media content logically underneath respective subcategories. Initially, however, one or both of the subcategory field or media content field are empty or collapsed.

As shown in block 114, the method also includes receiving selection of a category identified in the category field. In response to receiving the selection of a category, the method includes noting, in the category field of the GUI, the selected category, as shown in block 116. Also in response to receiving selection of a category, the method includes identifying, in the subcategory field of the GUI, one or more subcategories associated with one or more piece of media content, and in the hierarchy, logically underneath the selected category, as shown in block 118.

The method of this exemplary embodiment further includes receiving selection of a subcategory identified in the subcategory field, as shown in block 120. Similar to receiving selection of a category, in response to receiving the selection of a subcategory, the method includes noting, in the subcategory field of the GUI, the selected subcategory, the selected category continuing to be noted as the selected subcategory is noted, as shown in block 122. Also in response to receiving selection of a subcategory, the method includes identifying, in the media content field of the GUI, one or more pieces of media content logically underneath the selected subcategory in the hierarchy, as shown in block 124. The method then includes receiving selection of a piece of media content identified in the media content field to thereby access the respective piece of media content or information related thereto, as shown in block 126.

Various exemplary embodiments of the present invention have been explained in the context of accessing music media content. It should again be noted, however, that the media content may include other types of content in accordance with exemplary embodiments of the present invention. In one exemplary embodiment, the media content may comprise messaging content. In such instances, the messaging content may be associated with categories including different types of messages such as, for example, SMS, MMS, Email, postcard or the like. These categories may then be presented in the category field 90 of the GUI 86. The subcategory field 92, then, may display one or more functions that may be applied to a particular message, such as adding attachments or the like. And the media content field 94 may include a text box for entering content (e.g., text) for a message, or viewing content of a message.

In another exemplary embodiment, the media content may comprise image or picture content. In these instances, the image content may be associated with categories including different locations where the content may be stored (the media database 84 comprising one or more databases, or being spread over one or more storage locations). These locations may include, for example, embedded or removable MMCs, Memory Sticks, EEPROM, flash memory, hard disk or the like. These categories may be presented in the category field 90 of the GUI 86. The subcategory field 92, then, may display one or more subcategories such as one or more types of images such as, Bitmaps, JPGs, GIFs, or the like. And the media content field 94 may include a list of images stored in the media database.

As also explained above, the GUI 86 updates the subcategory and media content fields 92, 94 to identify one or more subcategories and pieces of media content, respectively, as a category and subcategory are selected or otherwise aligned with a respective frame 108, 108′. It should be understood, however, that in alternative embodiments the subcategory and media content fields may identify all applicable subcategories and pieces of media content in the media database 84. In such instances, upon selection or alignment of a category, the subcategory and media content fields may be updated to include only those subcategories and pieces of media content logically underneath the respective category in the hierarchy, the other subcategories and pieces of media content being removed from the respective fields (or otherwise displayed but rendered un-selectable). Similarly, upon election or alignment of a subcategory, the media content field may again be updated to include only those pieces of media content logically underneath the respective category and subcategory in the hierarchy, any further pieces of media content logically underneath the respective category but not the respective subcategory being removed from the respective fields (or otherwise displayed but rendered un-selectable).

According to one exemplary aspect of the present invention, the functions performed by one or more of the entities of the system, such as the terminal 10, origin server 22, workstation 30, digital broadcaster 32, or digital broadcast receiving terminal 36, may be performed by various means, such as hardware and/or firmware, including those described above, alone and/or under control of a computer program product. The computer program product for performing one or more functions of exemplary embodiments of the present invention includes a computer-readable storage medium, such as the non-volatile storage medium, and software including computer-readable program code portions, such as a series of computer instructions, embodied in the computer-readable storage medium.

In this regard, FIGS. 4 and 13 are a functional block diagram and flowchart, respectively, of systems, methods and program products according to exemplary embodiments of the present invention. It will be understood that each block or step of the functional block diagram and flowchart, and combinations of blocks in the functional block diagram and flowchart, can be implemented by various means, such as hardware, firmware, and/or software including one or more computer program instructions. As will be appreciated, any such computer program instructions may be loaded onto a computer or other programmable apparatus to produce a machine, such that the instructions which execute on the computer or other programmable apparatus (i.e., hardware) create means for implementing the functions specified in the block(s) or step(s) of the functional block diagram and flowchart. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the functional block diagram and flowchart. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the functional block diagram and flowchart.

Accordingly, blocks or steps of the flowcharts support combinations of means for performing the specified functions, combinations of steps for performing the specified functions and program instruction means for performing the specified functions. It will also be understood that one or more blocks or steps of the functional block diagram and flowchart, and combinations of blocks or steps in the functional block diagram and flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. For example, although the GUI 86 of exemplary embodiments of the present invention may be preconfigured as to the above-described displays, it should be understood that one or more of the displays may be user configurable or otherwise alterable. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus comprising:
a processor configured to present, in a display, a graphical user interface (GUI), the GUI filling a window area and including a category field, a subcategory field and a media content field, the category field identifying therein one or more categories associated with one or more pieces of media content, the categories being included in a hierarchy including one or more subcategories logically underneath respective categories, and one or more pieces of media content logically underneath respective subcategories, one or both of the subcategory field or media content field initially being empty or collapsed;
wherein the processor is configured to receive selection of a category identified in the category field, and in response to receiving the selection of a category,
note, in the category field of the GUI, the selected category, and
identify, in the subcategory field of the GUI, one or more subcategories associated with one or more piece of media content, and in the hierarchy,
logically underneath the selected category;
wherein the processor is configured to receive selection of a subcategory identified in the subcategory field, and in response to receiving the selection of a subcategory,
note, in the subcategory field of the GUI, the selected subcategory, the selected category continuing to be noted as the selected subcategory is noted, and
identify, in the media content field of the GUI, one or more pieces of media content logically underneath the selected subcategory in the hierarchy; and
wherein the processor is configured to receive selection of a piece of media content identified in the media content field to thereby access the respective piece of media content or information related thereto.

2. An apparatus according to claim 1, wherein the one or more categories comprise one or more criterion, and the one or more subcategories comprise one or more particular values of the respective one or more criterion.

3. An apparatus according to claim 1, wherein one or both of the category field or subcategory field is horizontally scrollable when identifying therein one or more categories or subcategories, respectively, and
wherein the media content field is vertically scrollable when identifying therein one or more pieces of media content.

4. An apparatus according to claim 1, wherein one or more of the category field, subcategory field or media content field includes therein a frame, the frame being movable with respect to the identified therein one or more categories, subcategories or pieces of media content, respectively,
wherein the processor is configured to receive selection of one or more of a category, subcategory or piece of media content aligned with the frame in one or more of the category field, subcategory field or media content field, respectively.

5. An apparatus according to claim 1, wherein the processor is configured to present a window area including a category field identifying therein one or more categories, one of the identified categories being aligned with a frame within the category field, and
wherein the processor is further configured to identify, in the subcategory field of the GUI and before receiving selection of a category, one or more subcategories associated with one or more piece of media content, and in the hierarchy, logically underneath the category aligned with the frame, the respective one or more subcategories being displayed but un-selectable unless and until selection of the respective category is received.

6. An apparatus according to claim 1, wherein when selection of a category is received, the category field is active and the subcategory and media content fields are inactive,
wherein when selection of a subcategory is received, the subcategory field is active and the category and media content fields are inactive, and
wherein when selection of a piece of media content is received, the media content field is active and the category and subcategory fields are inactive.

7. An apparatus according to claim 1, wherein the processor being configured to note the selected category includes being configured to display but render un-selectable one or more un-selected categories in the category field, and
wherein the processor being configured to note the selected subcategory includes being configured to display but render un-selectable one or more un-selected subcategories in the subcategory field.

8. An apparatus according to claim 1, wherein the processor is further configured to present the GUI further filling a second window area and including at least a second category field, the second category field identifying therein one or more categories associated with the selected piece of media content.

9. An apparatus according to claim 8, wherein the processor is further configured to receive selection of a category identified in the second category field, and in response to receiving the selection of a category,
note, in the second category field of the GUI, the selected category, and
identify, in the second subcategory field of the GUI, one or more subcategories associated with the selected piece of media content, and in the hierarchy, logically underneath the selected category; and
wherein the processor is configured to receive selection of a subcategory identified in the second subcategory field, and in response to receiving the selection of a subcategory,
note, in the second subcategory field of the GUI, the selected subcategory, the selected category continuing to be noted as the selected subcategory is noted, and
identify, in the second media content field of the GUI, one or more pieces of media content logically underneath the selected subcategory in the hierarchy, the identified one or more pieces of media content including the selected piece of media content.

10. A method comprising:
displaying a graphical user interface (GUI) of an apparatus, the GUI filling a window area and including a category field, a subcategory field and a media content field, the category field identifying therein one or more categories associated with one or more pieces of media content, the categories being included in a hierarchy including one or more subcategories logically underneath respective categories, and one or more pieces of media content logically underneath respective subcategories, one or both of the subcategory field or media content field initially being empty or collapsed;
receiving selection of a category identified in the category field, and in response to receiving the selection of a category,
noting, in the category field of the GUI, the selected category, and
identifying, in the subcategory field of the GUI, one or more subcategories associated with one or more piece of media content, and in the hierarchy,
logically underneath the selected category;
receiving selection of a subcategory identified in the subcategory field, and in response to receiving the selection of a subcategory,
noting, in the subcategory field of the GUI, the selected subcategory, the selected category continuing to be noted as the selected subcategory is noted, and
identifying, in the media content field of the GUI, one or more pieces of media content logically underneath the selected subcategory in the hierarchy; and
receiving selection of a piece of media content identified in the media content field to thereby access the respective piece of media content or information related thereto.

11. A method according to claim 10, wherein the one or more categories comprise one or more criterion, and the one or more subcategories comprise one or more particular values of the respective one or more criterion.

12. A method according to claim 10, wherein one or both of the category field or subcategory field is horizontally scrollable when identifying therein one or more categories or subcategories, respectively, and
wherein the media content field is vertically scrollable when identifying therein one or more pieces of media content.

13. A method according to claim 10, wherein one or more of the category field, subcategory field or media content field includes therein a frame, the frame being movable with respect to the identified therein one or more categories, subcategories or pieces of media content, respectively,
wherein receiving selection of one or more of a category, subcategory or piece of media content comprises receiving selection of one or more of a category, subcategory or piece of media content aligned with the frame in one or more of the category field, subcategory field or media content field, respectively.

14. A method according to claim 10, wherein displaying a window area comprises displaying a window area including a category field identifying therein one or more categories, one of the identified categories being aligned with a frame within the category field, and wherein the method further comprises:
identifying, in the subcategory field of the GUI and before receiving selection of a category, one or more subcategories associated with one or more piece of media content, and in the hierarchy, logically underneath the category aligned with the frame, the respective one or more subcategories being displayed but un-selectable out unless and until selection of the respective category is received.

15. A method according to claim 10, wherein when selection of a category is received, the category field is active and the subcategory and media content fields are inactive,
wherein when selection of a subcategory is received, the subcategory field is active and the category and media content fields are inactive, and
wherein when selection of a piece of media content is received, the media content field is active and the category and subcategory fields are inactive.

16. A method according to claim 10, wherein noting the selected category comprises displaying but rendering un-selectable one or more un-selected categories in the category field, and
wherein noting the selected subcategory comprises displaying but rendering un-selectable one or more un-selected subcategories in the subcategory field.

17. A method according to claim 10 further comprising:
displaying the GUI further filling a second window area and including at least a second category field, the second category field identifying therein one or more categories associated with the selected piece of media content.

18. A method according to claim 17 further comprising:
receiving selection of a category identified in the second category field, and in response to receiving the selection of a category,
noting, in the second category field of the GUI, the selected category, and
identifying, in the second subcategory field of the GUI, one or more subcategories associated with the selected piece of media content, and in the hierarchy, logically underneath the selected category; and
receiving selection of a subcategory identified in the second subcategory field, and in response to receiving the selection of a subcategory,
noting, in the second subcategory field of the GUI, the selected subcategory, the selected category continuing to be noted as the selected subcategory is noted, and
identifying, in the second media content field of the GUI, one or more pieces of media content logically underneath the selected subcategory in the hierarchy, the identified one or more pieces of media content including the selected piece of media content.

19. A computer-readable storage medium of a network entity, the computer-readable storage medium having computer-readable program code portions stored therein, the computer-readable program code portions comprising:
a first executable portion configured to display a graphical user interface (GUI) of an apparatus, the GUI filling a window area and including a category field, a subcategory field and a media content field, the category field identifying therein one or more categories associated with one or more pieces of media content, the categories being included in a hierarchy including one or more subcategories logically underneath respective categories, and one or more pieces of media content logically underneath respective subcategories, one or both of the subcategory field or media content field initially being empty or collapsed;
a second executable portion configured to receive selection of a category identified in the category field, and in response to receiving the selection of a category,
note, in the category field of the GUI, the selected category, and
identify, in the subcategory field of the GUI, one or more subcategories associated with one or more piece of media content, and in the hierarchy, logically underneath the selected category;
a third executable portion configured to receive selection of a subcategory identified in the subcategory field, and in response to receiving the selection of a subcategory,
note, in the subcategory field of the GUI, the selected subcategory, the selected category continuing to be noted as the selected subcategory is noted, and
identify, in the media content field of the GUI, one or more pieces of media content logically underneath the selected subcategory in the hierarchy; and
a fourth executable portion configured to receive selection of a piece of media content identified in the media content field to thereby access the respective piece of media content or information related thereto.

20. A computer-readable storage medium according to claim 19, wherein the one or more categories comprise one or more criterion, and the one or more subcategories comprise one or more particular values of the respective one or more criterion.

21. A computer-readable storage medium according to claim 19, wherein one or both of the category field or subcategory field is horizontally scrollable when identifying therein one or more categories or subcategories, respectively, and
wherein the media content field is vertically scrollable when identifying therein one or more pieces of media content.

22. A computer-readable storage medium according to claim 19, wherein one or more of the category field, subcategory field or media content field includes therein a frame, the frame being movable with respect to the identified therein one or more categories, subcategories or pieces of media content, respectively,
wherein one or more of the second executable portion, third executable portion or fourth executable portion is configured to receive selection of one or more of a category, subcategory or piece of media content, respectively, aligned with the frame in one or more of the category field, subcategory field or media content field, respectively.

23. A computer-readable storage medium according to claim 19, wherein the first executable portion is configured to present a window area including a category field identifying therein one or more categories, one of the identified categories being aligned with a frame within the category field, and wherein the computer-readable program code portions further comprise:
a fifth executable portion configured to identify, in the subcategory field of the GUI and before receiving selection of a category, one or more subcategories associated with one or more piece of media content, and in the hierarchy, logically underneath the category aligned with the frame, the respective one or more subcategories being displayed but un-selectable unless and until selection of the respective category is received.

24. A computer-readable storage medium according to claim 19, wherein when selection of a category is received, the category field is active and the subcategory and media content fields are inactive,
wherein when selection of a subcategory is received, the subcategory field is active and the category and media content fields are inactive, and
wherein when selection of a piece of media content is received, the media content field is active and the category and subcategory fields are inactive.

25. A computer-readable storage medium according to claim 19, wherein the second executable portion being configured to note the selected category includes being configured to display but render un-selectable one or more un-selected categories in the category field, and
wherein the third executable portion being configured to note the selected subcategory includes being configured to display but render un-selectable one or more un-selected subcategories in the subcategory field.

26. A computer-readable storage medium according to claim 19, wherein the computer-readable program code portions further comprise:
a fifth executable portion configured to present the GUI further filling a second window area and including at least a second category field, the second category field identifying therein one or more categories associated with the selected piece of media content.

27. A computer-readable storage medium according to claim 26, wherein the computer-readable program code portions further comprise:
a sixth executable portion configured to receive selection of a category identified in the second category field, and in response to receiving the selection of a category,
note, in the second category field of the GUI, the selected category, and identify, in the second subcategory field of the GUI, one or more subcategories associated with the selected piece of media content, and in the hierarchy, logically underneath the selected category; and
a seventh executable portion configured to receive selection of a subcategory identified in the second subcategory field, and in response to receiving the selection of a subcategory,
note, in the second subcategory field of the GUI, the selected subcategory, the selected category continuing to be noted as the selected subcategory is noted, and
identify, in the second media content field of the GUI, one or more pieces of media content logically underneath the selected subcategory in the hierarchy, the identified one or more pieces of media content including the selected piece of media content.
